(19) United States
(12) Patent Application Publication
(10) Pub. No.: US 2001/0022126 A1
(43) Pub. Date: Sep. 20, 2001

(54) Multiple cutting machine for rolls of kitchen paper and/or toilet paper

(76) Inventor: Giovanni Gambini, Pisa (IT)

Correspondence Address: James V. Costigan, Esq., HEDMAN, GIBSON & COSTIGAN, P.C., 1185 Avenue of the Americas, New York, NY, 10036-2601, US

(21) Appl. No.: 09/812,116

(22) Filed: Mar. 14, 2001

(30) Foreign Application Priority Data
Mar. 17, 2000 (IT) MI2000A 000562

(51) Int. Cl. B26D 3/16

(52) U.S. Cl. 83/471.2; 83/484; 83/490

(57) ABSTRACT

A multiple cutting machine for rolls of kitchen paper and/or toilet paper comprising a base (20) onto which are fed at least two rolls or logs (15) by means of a respective conveyor with pushers (12) towards a head (21) bearing a cutting disk (32) which is motor-driven (in 33), characterized in that said conveyor with pushers (12) is driven by a stepper motor (19) in steps equivalent to a predetermined length of finished rolls (34), that said head comprises an upper portal structure (21) which may be lifted and/or lowered with respect to the lower structure (20) and supports at least one trolley (30) which moves along a closed loop path, runs on guides (29) and transports said cutting disk (32), continuously activated, to bring said cutting disk (32) from a position of release from said at least two logs (15) to a cutting position engaged on them following a direction essentially parallel to said lower structure (20).

The present invention concerns a multiple cutting machine for rolls of kitchen paper and/or toilet paper.

For the production of rolls of kitchen paper and/or toilet paper from wound sticks or rolls with a predetermined diameter and a certain height, for example around two meters, and known as “logs”, they must be cut so as to realise single rolls, for example with length about 200 mm, ready for distribution.

Cutting to the predetermined size of these final rolls is carried out on special cutting machines which, for example, receive the single log and cut it in succession into a plurality of rolls, each of the required dimensions. Once winding of the log has been completed, it arrives on a pusher conveyor by means of which it is sent under a cutting machine.

This machine generally comprises a motor-driven cutting disc borne on an arm which is made to rotate, passing from a position of release from one or two underlying logs, advanced on the conveyor, to a position of engagement to cut one or more rolls from the respective logs and so on.

On the base of this work structure, the cutting disk is engaged on the logs or rolls to be cut, at most four underlying logs, following strictly circular paths which limit the diameter of the logs to be cut because of problems of possible interference between the parts. Since the logs are arranged in a cord formation with respect to circumference of the disc revolution, the central logs are more engaged by the cutting blade. Since the thickness of the cutting blade increases towards the centre, the cut performed is not uniform and there is overheating of the blade.

To accelerate these cutting operations, cutting machines have also been made which even follow the log or logs as they move along the pusher conveyor and cut them while they are in movement, trying to save time.

However, these devices are particularly complex and must be perfectly regulated so as not to produce rolls cut in different sizes or which are not perfectly cut according to the users' requests. Moreover, they present the same problems as the devices with a rotating arm mentioned above.

The aim of the present invention is to realise a machine for cutting logs into rolls of kitchen paper and/or toilet paper which overcomes the above mentioned problems.

Another aim is to realise a log cutting machine that is extremely simple and functional, while allowing the cutting work to be carried out at a good speed with a high production rate.

Another aim is to realise a log cutting machine that allows the discs to be used until their diameter is quite reduced, with a saving on costs and less interruptions to change the disk.

These and other aims according to the present invention are achieved realising a multiple cutting machine for rolls of kitchen paper and/or toilet paper as defined in claim 1.

Additional characteristics are contemplated in the dependent claims.

The characteristics and advantages of a multiple cutting machine for rolls of kitchen paper and/or toilet paper according to the present invention will be better explained in the following description, supplied purely as an example without limitation, referring to the enclosed schematic drawings, in which:

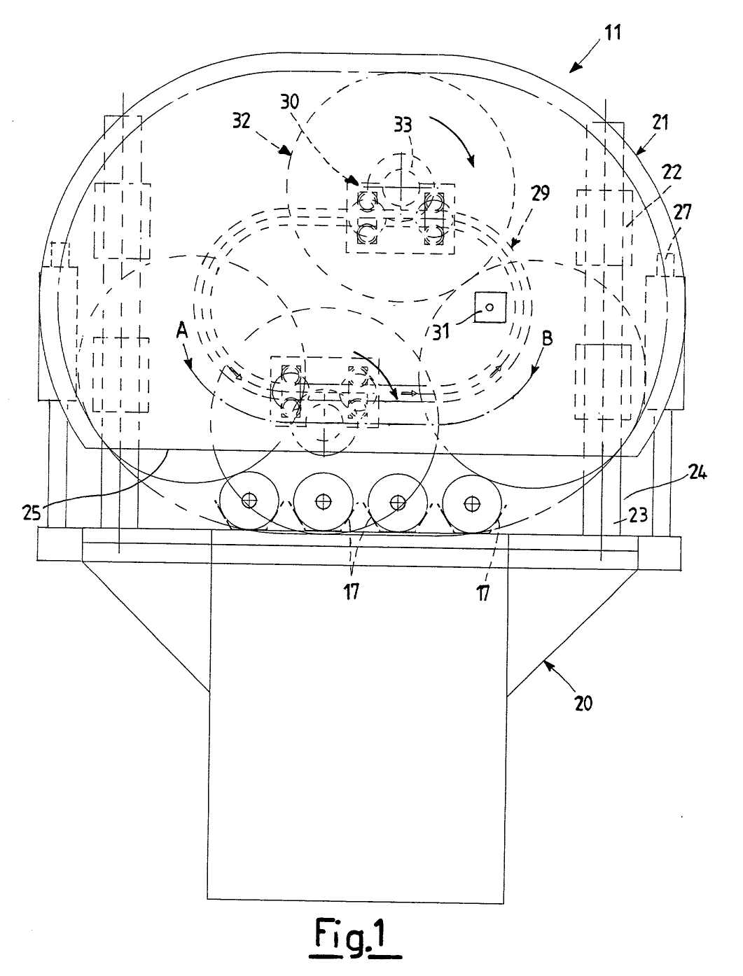

FIG. 1 is a schematic front view of a multiple cutting machine for rolls of kitchen paper and/or toilet paper according to the present invention,

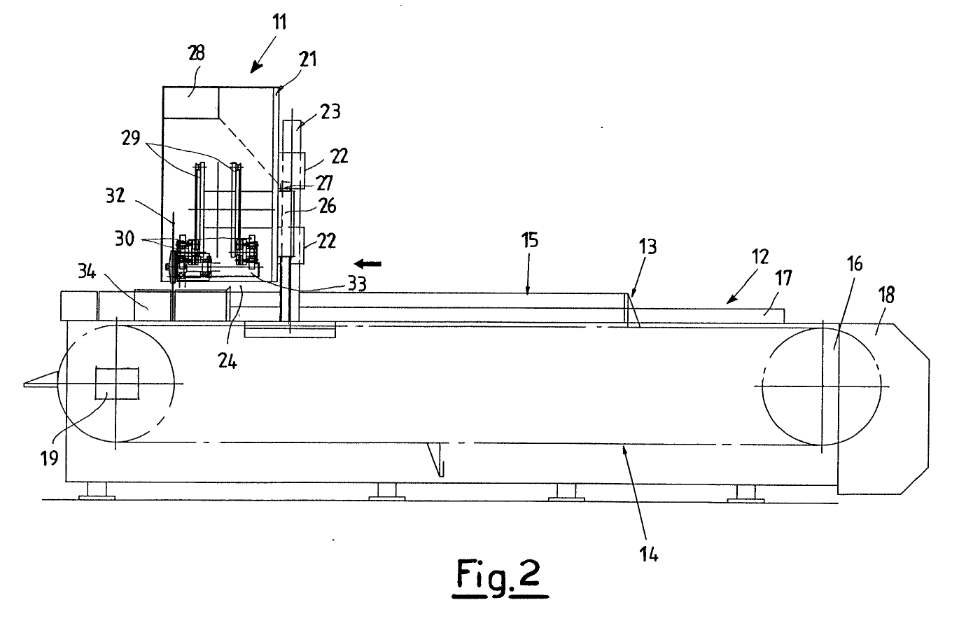

FIG. 2 is an elevated side view of the machine in FIG. 1.

With reference to the figures, a multiple cutting machine for rolls of kitchen paper and/or toilet paper according to the present invention is shown which is globally indicated with the number 11.

The cutting machine 11 is placed downstream from a pusher conveyor 12 which, by means of single pushers 13, carried by a chain 14 looped around the end pulleys 16, feeds logs 15 to be cut to the predetermined size into a series of rolls. In the example the conveyor 12 is a conveyor with four channels 17 placed on a bench 18 and it is driven by a stepper motor 19 or a motor that can be activated to determine its advance in steps of predeterminable quantities. Generally the motor is a stepper motor operated in steps equivalent to a predetermined length of finished rolls.

Special pressing devices (not shown) hold the logs 15 and are engaged on them when they have been advanced by the determined step under the cutting machine 11.

This cutting machine 11 comprises a lower bearing structure 20 and an upper portal structure 21 which may be lifted and/or lowered with respect to the lower structure 20 which is a natural continuation of the bench 18.

The portal structure 21, which forms the head of the cutting machine, presents sleeve guides 22 sliding on cylindrical uprights 23 which extend upwards, fixed to the lower structure 20 and with adjustable height. In this way it is possible to regulate a lower opening 24 situated between a lower surface 25 of same and the lower structure 20 or the bench 18 depending on the diameter of the logs 15 and the diameter of the cutting discs.

This portal structure 21 is moved by a pair of jacks 26 placed between it and the lower structure 20 and controlled by a central geared motor 28 and an encoder 27 which controls the vertical position, placed on one of the two jacks 26.

The portal structure 21 carries a pair of guides 29, lying on a vertical plain, on which, in the example, slide two trolleys 30 driven by belts (not shown), made to slide on said guides 29, by means of a motor 31. Each trolley 30 is thus made to slide with constant movement along the guides 29 following a flattened loop path, and it carries a cutting blade or disc 32 which is motor-driven in 33.

In the bottom part of this path, in a section substantially almost parallel to the bench 18, indicated by A and B in the section travelled by the axis of rotation of the disc 32, the disc acts on the underlying logs 15 lying in the channels 17, cutting rolls 34 of the size previously selected.

The example shows how said two trolleys 30, each carrying a cutting blade or disc 32, which intervene in subsequent moments after the cutting action of the one disc has been performed on the logs at rest, the advance to size of the logs and the cutting of the other disc on the logs advanced by the predetermined size. In this way cooling of the discs is achieved between one cut and the next, with an improvement in cutting.

It is clear that, to complete the machine, systems may be provided for sharpening the discs, protections of the rotating and moving parts and assemblies for regulating the logs and the rolls thus obtained.

The advantage of log cutting machine according to the present invention lies substantially in the fact that it operates without interruption thanks to the continuous rotation of the trolleys carrying the discs or blades, of which there may be any number desired.

Moreover, the discs cut on the almost rectilinear section A-B of the flattened loop path with a limited space for entering and entering the path, with an improvement in the cutting quality, due essentially to the geometry of the cutting course and to the slower advance speed of the disc in the material resulting from the shorter path required for each cut. Moreover, as an effect of the straight course, the crown of the cutting blade or disc engaged is shorter and constant. On the contrary, in the known cutting machines with a rotating arm, cutting is performed in the arc of a circle which, in contact with the logs, generates a circular cutting course with progressive engagement in the logs, variation of the thickness of the blade or disc, and a cut which is not completely correct. For example, in order to cut several logs or rolls it is thus necessary to have a particularly large arm rotation circumference which involves greater cutting speeds at the expense of the quality of the product obtained. These problems increase as the cutting disk diameter decreases due to wear. All this is avoided according to the present invention.

Due to the engagement of the cutting disc in an almost rectilinear course during its active phase, it is also possible to operate on logs with larger diameters without problems of interference with the machine parts and intolerable variations in the thickness of the disc areas that come in contact with the log to be cut, as happens in the machines with a rotating arm known up till now. In this way it is also possible to work with discs with a reduced diameter on logs of a certain diameter, which was not possible with the previous machines.

Moreover, with this machine cutting is performed in several channels for various logs at the same time, with an increase in the production rate. Operation of this kind is not possible with a rotating arm which presents operating limits due to its geometry and cannot work on more than four logs simultaneously.

However it is also possible to use more discs than those indicated, having a longer path with more trolleys and more channels containing the respective logs fed by pushers.

The possibility of regulating the lower opening 24 or distance situated between the lower surface 25 of the upper portal structure 21, which may be lifted and/or lowered with respect to the lower structure 20, allows regulation of the distance as a function both of the diameter of the logs 15 and of the diameter of the cutting discs. By lowering the upper portal structure 21 it is even possible to make maximum use of the cutting discs 32 as their diameter gradually decreases as a result of the cuts made.

The jacks in fact rapidly position the parts as a function of the disc diameter and/or of the diameter of the log to be cut.

It is also possible to provide for separate mechanisms for the pushers 13 of adjacent and different channels 17. In this way, as soon as the cutting disc 32 has cut a roll from the log in the first channel 17 and moves on to the log in the next channel, the first log can be immediately moved forward for the next cut, saving on work time. In this way, in fact, there must be separate mechanisms, such as for example various motors 19, for each of the channels 17 with independent operation.

A cutting machine according to the present invention thus solves all the problems of the previous art, and allows simple and reliable handling of rolls of any diameter and any number without any problem, allowing a high machine production rate.

1. Multiple cutting machine for rolls of kitchen paper and/or toilet paper comprising a base (20) onto which are fed at least two rolls or logs (15) by means of a respective pushers conveyor (12) towards a head (21) bearing a cutting disk (32) which is motor-driven (in 33), characterised in that said conveyor with pushers (12) is driven by a stepper motor (19) in steps equivalent to a predetermined length of finished rolls (34), that said head comprises an upper portal structure (21), set at a distance with respect to a lower structure (20) and supports at least one trolley (30) which moves along a closed loop path, runs on guides (29) and transports said cutting disk (32), continuously activated, to bring said cutting disk (32) from a position of release from said at least two logs (15) to a cutting position engaged on them following a direction essentially parallel to said lower structure (20).

2. Machine according to claim 1, characterised in that said upper portal structure (21) may be lifted and/or lowered with respect to a lower structure (20).

3. Machine according to claim 2, characterised in that said upper portal structure (21) presents sleeve guides (22) sliding on cylindrical uprights (23) which extend upwards, fixed to the lower structure (20), a pair of jacks (26) being provided, placed between it and said lower structure (20), controlled by a central geared motor (28).

4. Machine according to claim 1, characterised in that said closed loop path on which slides at least one trolley (30) lies on a vertical plain.

5. Machine according to claim 4, characterised in that said closed loop path presents at the bottom a section substantially parallel to said lower structure (20) (from A to B) in which each cutting disc (32) acts on underlying logs (15) lying in the channels (17) of a bench (18) of said conveyor (12), cutting rolls (34) of the size previously selected.

6. Machine according to claim 1, characterised in that, in said closed loop path there are at least two trolleys (30) which are caused to move continuously, as the cutting discs (32) which they carry also rotate continuously.

7. Machine according to claim 1, characterised in that each log (15) is advanced in a separate channel (17) and each channel (17) has its pushers (13) and mechanism (19) separate from those of other parallel channels (17).
